(19) United States
(12) Patent Application Publication
(10) Pub. No.: US 2010/0121919 A1
(43) Pub. Date: May 13, 2010

(54) System and a method for sharing information interactively among two or more users

(75) Inventors: Sam de-Jongh Hepworth, Struer (DK); Aviaja Borup Lynggaard, Aarhus C (DK); Lyle Bruce Clarke, Lunderskov (DK); Paul Spange, Odder (DK); Marianne Graves Petersen, Lystrup (DK); Kaj Georg Grønbæk, Aarhus N (DK); Peter Gall Krogh, Hojbjerg (DK)

Correspondence Address: HARNESS, DICKEY & PIERCE, P.L.C., P.O. BOX 8910, RESTON, VA, 20195, US

(73) Assignee: Arhus Universitet

(21) Appl. No.: 12/591,232

(22) Filed: Nov. 13, 2009

Related U.S. Application Data
(60) Provisional application No. 61/193,388, filed on Nov. 24, 2008.

(30) Foreign Application Priority Data
Nov. 13, 2008 (DK) PA 2008 01575

(51) Int. Cl. G06F 15/16

(52) U.S. Cl. 709/204

(57) ABSTRACT

An assembly of a plurality of media providers, each media provider having set a media exchange level. Each media exchange level comprising or encompassing one or more types of media to be exchanged. The media providers outputting to the other media providers the set levels, and if two media providers have levels set which have at least one type of media to be exchanged in common, the exchange of such media is started automatically. Media types to exchange may be photos, podcasts, music, voice, videos & movies, streamed TV/video/audio, such as airborne transmissions, graphics & text, e-mails, running application programs, such as an active web browser window, or the like

This is application claims priority under 35 U.S.C. §119 and to U.S. Provisional Application No. 61/193,388, filed on Nov. 24, 2008 as well as Danish Application no PA 2008 01575 filed on Nov. 13, 2008, the contents of both of which are hereby incorporated by reference in their entirety.

The present invention relates to a method and a system for user friendly access to media information and presentation of the same, e.g. accessing and presenting information related to multimedia files, and interactively sharing the information among two or more users.

The huge amount of available digital information in terms of files and/or streams with music, video, photos, text, graphics enables more advanced and interactive uses of multimedia information. This information may be accessed from physical devices and/or from virtual devices on the Internet, e.g. it may reside on service providers in cyberspace.

Commercial systems for sharing multimedia information are available on the market and have become very popular among users. Examples are Facebook, Netlog and Messenger. These are typical systems that act with a social aspect to share information (like photo, music, video, blogs, e-mail) and interests (like profiles, interest group, friends). That kind of systems works in public domains, that's accessible by everyone having access to the Internet.

In a first aspect, the invention relates to an assembly comprising two or more media providers being adapted to communicate with each other, wherein:
each media provider is adapted to receive selected level information relating to one of a plurality of media exchange levels, each media exchange level identifying one or more of a predetermined plurality of different types of media information to exchange,
at least one of the media providers is adapted to output its selected level information to one or more of the other media providers,
one or more of the media providers, each having predetermined level information, being adapted to:
   receive first level information from the at least one media provider,
   compare the pertaining media provider's selected level information to the first level information and
   if one or more types of media information are in common between the first level information and the pertaining media provider's selected level information, initiate data exchange with the at least one media provider, the data exchange taking place with all the types of media information in common.

In the present context, an assembly is a plurality of media providers which usually are positioned in different positions, such as in different rooms of a house and/or in different houses, cities, countries or the like.

In the present context, a media provider is an apparatus which is adapted to provide media, events or experiences to a user. The media provider may access/read/receive such media from a number of sources.

Any type of media/events may be shared:
photos from local libraries and/or from remote servers;
podcast from local libraries and/or from remote servers;
music from local libraries and/or from remote servers;
videos & movies from local libraries and/or from remote servers;
streamed TV/video/audio from sources, such as airborne transmissions;
graphics & text from local libraries and/or from remote servers;
e-mail from service provider;
a running application program e.g. an active web browser window.

A media provider according to the invention usually is able to provide picture and sound information and means enabling control of the media provider itself and the establishing of the interactive connection among users:
a multimedia system like a TV system with screen/display/monitor and loudspeakers;
a multimedia system like an Audio system with loudspeakers and display;
A PC or Laptop computer (e.g. an iMac, MacBook, IPhone, iTouch and iPod;
a multimedia controller, like an interactive two-way communication controller, enabled to display information and receive/send control commands wirelessly from/to a multimedia system via standard means e.g. infrared, Bluetooth or WiFi.

The communication between the media providers may be performed in any desired manner, such as via a wireless or a wired connection using any desirable data transfer protocol, such as Ethernet, Bluetooth or the like. It is noted that if the media providers are provided close to each other, such as within a house, shorter range communication, such as Bluetooth or communication over the electrical wires of the house, may be used, whereas communication between media providers provided in different houses, cities or countries may take place over e.g. telephone cables, optical fibres ans/or satellites. Thus, it may be preferred that a media provider is adapted to perform different or multiple types of communication to take these types of situations into account.

Naturally, this data communication may carry both the media to be exchanged as well as the information relating to a set level.

In the present context, a type of media information to exchange relates to different types of media. It is noted that video may be of different types depending on what the video illustrates. One type of video is e.g. a movie accessed by one media provider from e.g. a TV signal or a local BlueRay player. Another type of video is a live video feed from a webcam or the like imaging the viewer of the TV or media provider. In addition, audio information may be of one type if e.g. being music derived from a radio feed or a local player and of another type if being a live recording of a user of the media provider.

Each media exchange level thus represents or enables exchange of one or more of the different types of media. A plurality of such levels exist, from which the level information for each media player is selected.

Each media player has a selected level. This setting may be user-defined, as is described above, or may be hard-coded. In one situation, the media level of a media provider may depend on the capabilities of the media player, such as allowing only exchange of video/images if comprising a display/monitor.

At least one of the media providers is adapted to output its level information to one or more of the other media providers. In this manner, the other media providers will be informed of the desire or capabilities of this one media provider.

The one or more of the media providers, each having selected level information set, will then receive this information and compare it to the setting of the individual media provider.

If one or more types of media information are in common between the first level information and the pertaining media provider's selected level information, both media providers are set to at least this type of media information. In this situation, data exchange is initiated with the at least one media provider, the data exchange taking place with all the types of media information in common. Thus, the data exchange is automatic.

It is noted that the media type(s) in common may be transferred in any direction between the two media providers.

In one situation, the at least one media provider outputting its level information may output this information as a “I′m bored” signal. Thus, if other media providers, having the at least one media type in common, receives this “signal”, a media of this type may be transferred from the “receiving” media provider to the “bored” media provider.

In the opposite situation, the at least one media provider outputting its level information may be instructed to do so, when an interesting medium or file is received and it is desired to share this with others. Thus, once this type of media is in common with another media provider, this medium/file is exchanged.

Naturally, if a lot of media providers are provided, the individual media provider may be set to output its level information only to a predetermined group of media providers. As is known from contacts management in computers and a number of chat sites, such as Messenger, MSN, different rules may be defined for different contacts or groups of contacts. Thus, different status/level information may be set for each group, and if data exchange takes place with a user from one group, the level for other groups, such as lower ranking groups, may be altered.

Also, a group may be selected, whereby the status/level of users of that group may be received or provided to the user, if not all users' status/levels are desired provided.

If, in one situation, a media provider exchanges media with another provider within a given group, other providers in the same group may also exchange the same media; such additional providers then receive the shared media. In addition, if media are shared in both directions (such as tele/video conference), each of the providers may receive the media from all other providers.

In one situation, a plurality of the media providers are adapted to access video media and exchange video media information, one of the types of media information being video media information. In this situation, if a level is set comprising video media exchange as a media type, and if first information is received with a level also having video media exchange, video media may be exchanged between the two media providers.

As mentioned above, the video media may be transmitted by the media provider outputting the first information to the other media provider, or the video media may be output by the media provider receiving the first information to that outputting it. This is a matter of taste or a matter of why the first information is output.

In this context, video media may be pre-recorded video, such as a file accessed or read by the media provider. “video media” may be movies, shows, TV-programs, or the like. Usually, the video media may also be provided to a user by the media provider transmitting the video media to the other media provider.

As to the available video media, these may be available to the user or the system in a variety of manners. Some events may be the user's property and may be available from a central storage or via portable storage elements (CDs/CD-ROMs/DVDs/hard discs/podcast/USB-keys/memory cards or the like). Other video media may be available from more remote sources, such as from airborne TV channels or other computers, via a network, such as the WWW and/or LANs, WANs or the like. Further video media may be available for purchase, such as for download via the WWW from external suppliers or servers.

Naturally, another type of media information may be audio media which, as the video media, are pre-recorded audio or audio received from other sources, such as music tracks, radio programs or the like. These may be available from the same types of sources as those mentioned for video media, with the addition of airborne radio signals.

In a second situation, a plurality of the media providers comprise means for deriving audio information from their surroundings and for exchanging audio information, one of the types of media information being audio information.

In one embodiment, audio information may be exchanged in both directions, so that both media providers derive the audio information and exchange it with each other. In this situation, the audio information preferably is derived or obtained in real time and transmitted to the other media provider as soon as possible. An example is a teleconference type or telephone type conversation where audio derived at two positions is exchanged. In the present context, the surroundings of a media provider may be defined as an area or volume neighbouring to the media provider, such as defined by the receiving characteristics of one or more microphones of the media provider used for deriving or detecting the sound.

In another embodiment, a plurality of the media providers comprise means for deriving image/video information relating to their surroundings and for exchanging such image/video information, one of the types of media information being image/video information. As is the situation with the audio exchange, the image/video information preferably is derived or obtained in real time and transmitted as soon as possible, as for e.g. a video conference. In this respect, the surroundings of the media provider may be defined by the viewing characteristics of a camera (still camera or video camera) of the media provider used for deriving the image/video information.

Naturally, the above situations may be combined. Further below, an ordering of the levels is preferably defined. If a given, higher, level is selected at two media providers communicating with each other, these may exchange video media, such as a TV programme or a movie, while interchanging audio, such as voice, and video information, such as images of the two (or more) users. Thus, a monitor at each media provider may provide both the video media (TV programme/movie) as well as an image of the other user, while speakers of the media provider provide the sound of the TV programme/movie as well as that received from the other user.

In the present context, a display or monitor may be any type of display or monitor, such as a flat screen monitor, a CRT, a LED/LCD/OLED or the like monitor. The display may be a stand-alone display/monitor or may form part of a multimedia system holding or storing the media/events and which may also be able to provide events to the user.

Preferably, one or more of the media providers comprise means for a user to determine or alter the, selected, level information. This setting may be any type of setting, from rotating a rotatable knob of the media provider to setting the setting in a menu of a graphical user interface thereof. Also, spoken instructions, movements of the user or other elements may be detected and interpreted as instructions. The level may be a selection of one or more media types to exchange, or pre-set levels may be selected from.

Preferably, the determining/entering means of the at least one of the media players comprises a monitor/display for displaying selected level information to the user. Naturally, a plurality of manners may exist. An exceptionally interesting embodiment is one wherein an ordering exists between the media exchange levels, each media exchange level having all types of media information of all lower ordered levels and at least one additional type of media information not present in any of the lower ordered levels. In this manner, a higher level will have more types of media to exchange.

Preferably, the ordering of the levels is defined after the amount of effort or share of personal life involved. Thus, sharing audio media, such as a music track, may be seen as a lower level of sharing and sharing a video media, such as a TV programme, is slightly higher level of sharing effort or of personal life. Then, the sharing of audio is a higher level, as the user now has to occupy himself actively in the process, and a sharing also of live video is an even higher sharing of personal life, as the presence of the user is required, and the interest or activeness of this user is obvious to the other party.

The user may then start out at a relative low level, and as the media exchange gets more interesting to the user, a higher level may be selected in order to exchange more types of media. In one situation, a starting level may be that of exchanging video (such as TV programmes or movies). If the user wishes to comment on the received/exchanged video, the level may be increased to a level also comprising exchanging audio. From there, the user may increase the level further to also comprise exchanging live video, so that the user may view the other user while exchanging audio and viewing the exchanged video (TV programme or movie).

A particularly interesting embodiment is one wherein images or pictograms are illustrated on a display/monitor for each level, the images/pictograms being provided on the display/monitor along a predetermined curve and in the order of the levels, the image/pictogram of the predetermined or selected level being highlighted. Thus, the individual levels may be provided at individual positions along the curve and in increasing or decreasing order along the curve. Increasing or decreasing the level then will be illustrated as a movement along the curve.

In this regard, the highlighting may be to alter the presentation of the actual image/pictogram in any desired manner, such as a change in colour or size, or the providing of additional elements adjacent to the image/pictogram.

Naturally, the first information identifying the selected level of another media provider may also be illustrated at or by the images/pictograms, such as providing another element adjacent to the image/pictogram defining the selected level of that media provider.

In one situation, the curve is a straight line, and the individual levels are illustrated along the line. This line may be provided at a lower edge of the monitor/display, an upper edge, or a side edge. Alternatively, a circular curve may be used emulating a rotatable knob, or a curve along the edges of the monitor/display, so that video etc. may be provided inside the curve.

Another aspect of the invention relates to a media provider for use in the assembly according to the first aspect.

A third aspect of the invention relates to a method of exchanging media information between two or more media providers communicating with each other, wherein:
each media provider receives selected level information relating to one of a plurality of media exchange levels, each media exchange level identifying one or more of a predetermined plurality of different types of media information to exchange,
at least one of the media providers outputs its level information to one or more of the other media providers,
one or more of the media providers, each having predetermined level information:
   receives the first level information from the at least one media provider,
   compares the pertaining media provider's predetermined level information to the first level information and
   if one or more types of media information are in common between the first level information and the pertaining media provider's predetermined level information, initiates data exchange with the at least one media provider, the data exchange taking place with all the types of media information in common.

In one situation, a plurality of the media providers access video media and exchange video media information, one of the types of media information being video media information.

In that or another situation, a plurality of the media providers derive audio information from their surroundings and exchange audio information, one of the types of media information being audio information.

In a further situation, a plurality of the media providers derive image/video information relating to their surroundings and exchange image/video information, one of the types of media information being image/video information.

Preferably, the method further comprises the step of a user entering level information into at least one of the media providers. Then, the level information may be altered/selected to the desire of the user.

Preferably, the method further comprises the step of displaying, on a display/monitor of a media provider, selected level information to a user. This selected level information may be pre-set and/or alterable by the user. Then, an ordering may exist between the media exchange levels, each media exchange level having all types of media information of all lower ordered levels and at least one additional type of media information not present in any of the lower ordered levels. In this situation, images or pictograms could be illustrated on the display/monitor for each level, such as images/pictograms being provided on the display/monitor along a predetermined curve and in the order of the levels, the image/pictogram of the set level being highlighted.

As mentioned above, the selected level of other media providers, such as determined from received first information, may also be illustrated.

Naturally, in the order, more additional settings/levels may be defined which do not leave room for any exchange of media at all. Thus, a setting/level may be to operate the media provider as a standard provider without outputting first information and without showing the first information from other users, one setting/level may be one in which first information from other users is illustrated but none output, and another setting/level may be “off”. Other levels may relate to the emphasis put on a type of media sharing. For example, different levels may relate to the exchanging of video information, where the size of the window on the display/monitor differs.

The preferred settings/levels are positioned on a linear “slider” and are:

| Name | Max you can do | You inspire others | Others inspire you |
|---|---|---|---|
| System standby | You cannot listen or | None present on | You are not present |
| | watch media | slider | on slider |
| | sources | | |
| Undisturbable | You can watch and | None present on | You are not present |
| | listen to your own | slider | on slider |
| | media sources | | |
| Invisible | You can watch and | They are present on | You are not present |
| | listen to your own | slider, and you can | on slider |
| | media sources | see metadata of | |
| | | their current media | |
| Available | You can watch and | They are present on | You are present on |
| | listen to your own | slider, and you can | slider, and they can |
| | media sources | see metadata of | see metadata of |
| | | their current media | your current media |
| Media connectable | You can watch and | They are present on | You are present on |
| | listen to the same | slider, and their | slider, and their |
| | media sources as | current media | current media |
| | them, and in sync | metadata is the | metadata is the |
| | | same as yours | same as yours |
| Audible | You can watch | They are present on | You are present on |
| | and/or listen to the | slider, and their | slider, and their |
| | same media sources | current media | current media |
| | as them, and in | metadata is the | metadata is the |
| | sync, and you may | same as yours; | same as yours; |
| | have a voice | You can hear them, | They can hear you, |
| | conversation | and know that they | and know that you |
| | (talk/hear) to/from | can hear you. | can hear them. |
| | them | | |
| Viewable - small | You can watch and | They are present on | You are present on |
| Viewable - medium | listen to same | slider, and their | slider, and their |
| Viewable - big | media sources as | current media | current media |
| | them, and in sync, | metadata is the | metadata is the |
| | and you may have a | same as yours; | same as yours; |
| | video conference | You can hear and | They can hear and |
| | conversation (see | see them, and know | see you, and know |
| | and hear) to/from | that they can hear | that you can hear |
| | them | and see you. | and see them. |

In the following, preferred embodiments of the invention will be described with reference to the drawing, wherein:

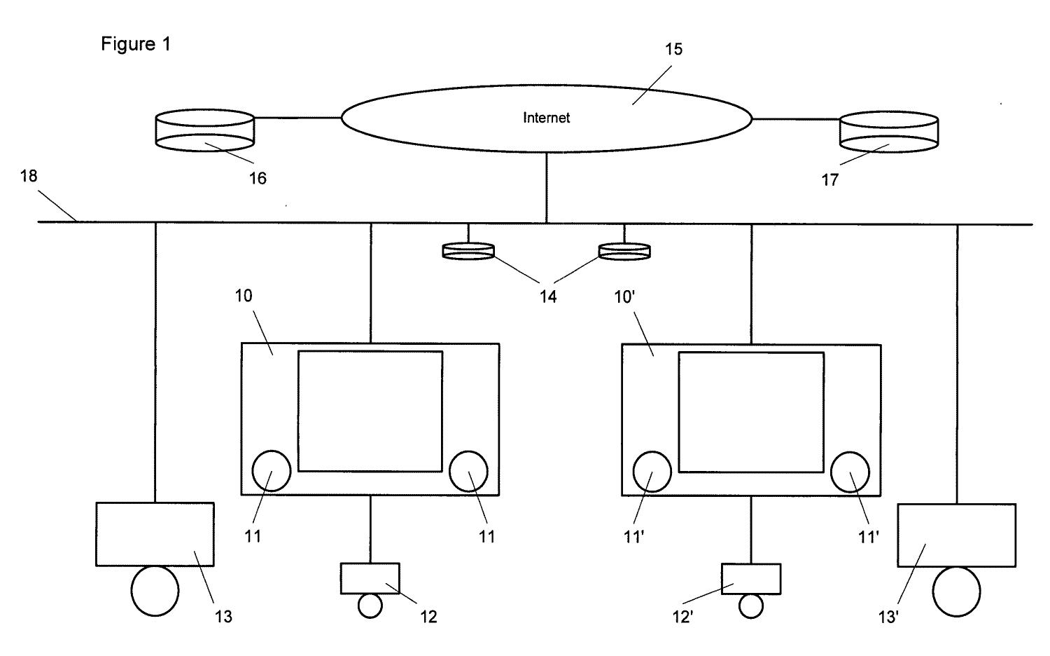

FIG. 1 illustrates a configuration including two multimedia systems interconnected and with access to the Internet;

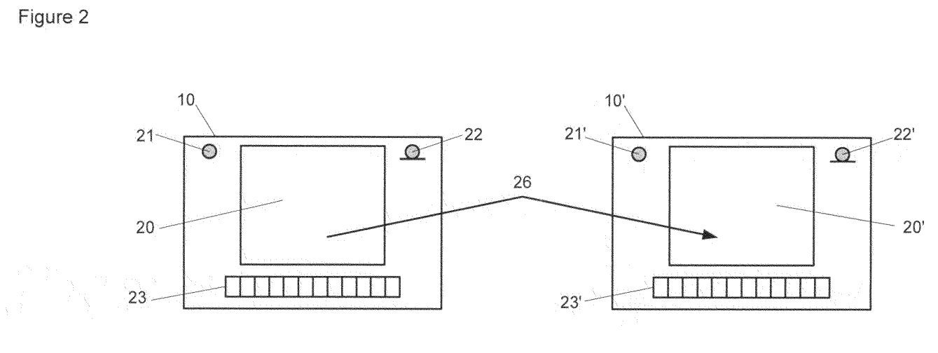

FIG. 2 illustrates an example of the multimedia system display outline in the shared mode of operation;

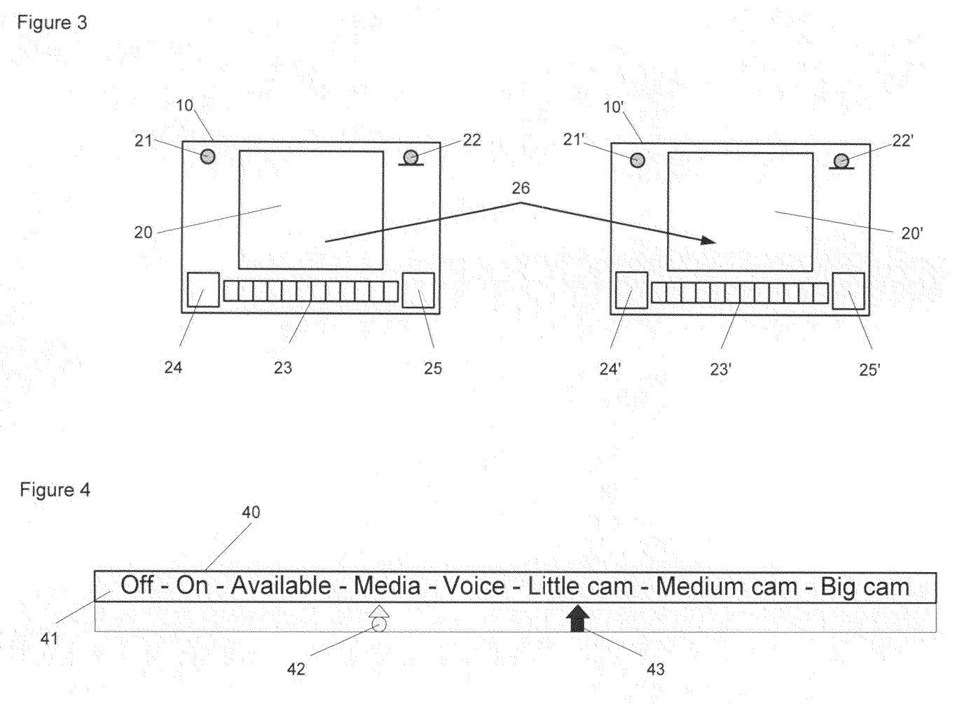

FIG. 3 illustrates another example of the multimedia system display outline in the shared mode of operation;

FIG. 4 illustrates an example of the status bar and slider;

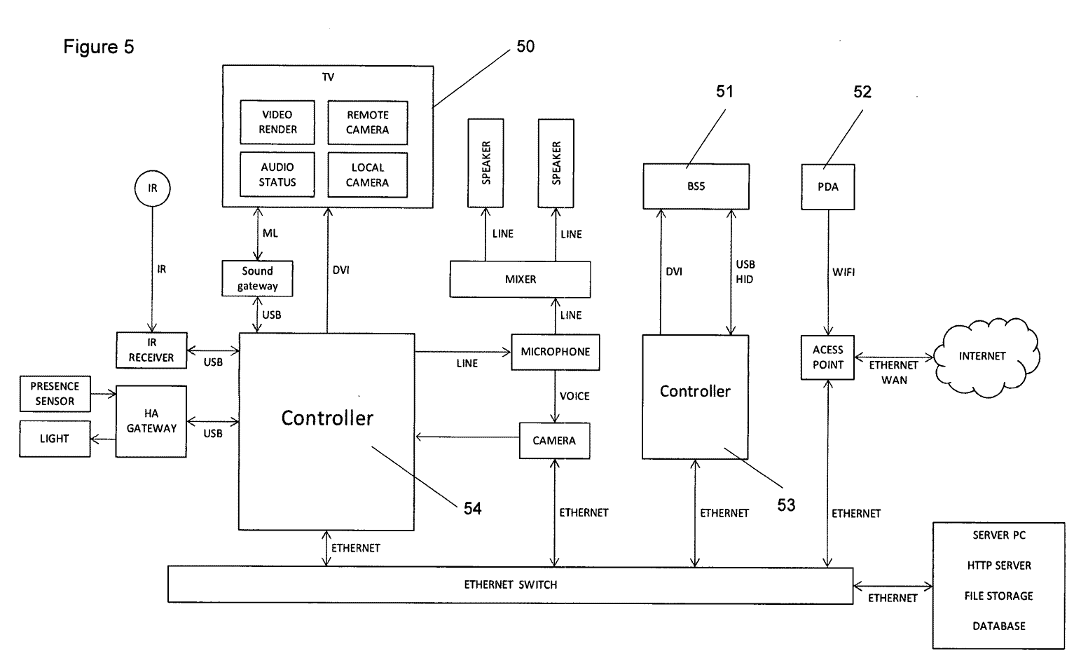

FIG. 5 illustrates a system block diagram of one embodiment.

In general, the present embodiments may be used in or be a part of a media player, a multimedia centre, a TV, an audio system, a DVD/CD player, a computer or any other type of element having access to or storing events and having a display.

In the present embodiment, the events or media may be audio, video, images, movies, songs, pictures, broadcast TV/sat programme, podcast, live show of any kind, any type of music (radio/video, live, or recorded), web browsing, viewing images/pictures/photos, activities (playing games, browsing, exercising, sports, communicating with others in any manner, such as texting/SMS and/or e-mail), and running applications on a PC (internet browsing) to access social networks and alike.

Visual information, or objects, is/are provided for available events. Even though this may be any visual information, it should be adapted to remind the user of the actual event, and could be transmitted to the other media providers, such as in the first information also comprising the selected level information. Thus, an object may be the cover of an album or a movie, or in the situation of an image or picture, the image or picture itself. An event may also be a group of events, such as a whole album or all images/pictures from a given event, such as a holiday. In that situation, the object provided may be representative for all events in the group of events.

The player comprises means (not illustrated) adapted to store or gain access to the events. All of or some of the events may be stored in or on the apparatus, such as in the electronics (not illustrated), such as in the form of a RAM, ROM, PROM, EPROM, EEPROM, Flash, disc, card (SD, miniSD, microSD or the like), hard disc or the like or may be one or more CD-ROM/DVD discs, and/or electrical, magnetic, or optical, or the like, storage.

Alternatively or in addition, all of or some of the events/media may be available thereto from a number of sources, such as from a near-by or internal storage, a remote storage, via a network of any type, or by being streamed from an external source, such as via the WWW or via airborne signals, such as TV or radio signals. This access and communication is handled by electronics (not illustrated), which comprises or communicates to or via e.g. one or more networking elements, such as NIC's, network adapters, wireless communication devices, routers, switches, Bluetooth elements, IR communication elements, other computers or servers, thin clients, intranets, the WWW, WANs, LANs or the like

The controlling means may be any type of controller, microchip, microprocessor, DSP, FPGA, hardwired or software controlled, or the like.

In addition, the player comprises a controller which controls the display and determines which objects to display and how to display these.

Different embodiments of the multimedia player may be applied:
A full featured TV set with network connection and enabled for wireless control from a remote commander.
Optionally a built-in camera and a microphone is embedded as well.
A full featured Audio player including a display and with network connection and enabled for wireless control from a remote commander.
Optionally a built-in camera and a microphone is embedded as well.
A full featured computer like a PC/laptop with network connection and enabled for wireless control from a remote commander.
Optionally a built-in camera and a microphone is embedded as well.
An advanced interactive two way remote controller including a display. Optionally a built-in camera and a microphone is embedded as well.

FIG. 1 illustrates a configuration including two multimedia systems interconnected and with access to the Internet;

Two or more multimedia devices (10,10′), e.g. a TV set with speakers (11,11′), are connected via a local network (18). Optionally disk devices or servers may appear as resources (14) as well. Furthermore, a connection to the internet (15) is provided, which enables access to multimedia information and contents, files, application programs, utilities and services from servers (17) and from service providers (16).

The infrastructure is based on standard technology connected, such as wired or wireless networks as appropriate according to given system requirements.

FIG. 2 illustrates an example of the multimedia system display in the shared mode of operation;

Two multimedia devices (10,10′), e.g. two TV sets with speakers, are connected via a local network (18). One device (10) is located in one house/room and another device (10′) is located in a different house/room. The two houses/rooms are connected via a network (26) which may be a local network and/or via a worldwide network like the Internet.

A common status bar is displayed on each of the multimedia devices (23,23′) and reflects the results of the control, requests and acceptances given by the users of each system (10, 10′).

To support the interactive chat and video functionality among users, every device (10,10′) has camera (21,21′) means and microphone (22,22′) means.

When a sharing of media files has been established, the multimedia systems are synchronized to provide the same media, sound and picture, to the users on every multimedia system (20,20′).

FIG. 3 illustrates in addition to the outline in FIG. 2, which video/pictures are related to a media sharing with an interactive chat session among two users. A video/picture of the first user is displayed in one window (24,24′) and a video/picture of the second user is displayed in another window (25,25′).

FIG. 4 illustrates an example of the status bar and slider (40). The status bar combines in one representation:
Sharing mode options to select,
Sharing mode status as is,
Actual selection made by every user

The outline of the status bar may be according to actual product requirements; thus it may be textual, graphical with icons and/or interactive.

Selections of options may be carried out in a manner of ways, such as by using a pointing device/mouse, moving another object, such as by rotation or sliding, operating a touch pad/screen, entering oral command or textual input, or the like.

The example illustrates a combined textual, icons and slider concept. The example is just an example and does not limit the scope of the invention.

The options/levels (41) are aligned in order:

### Off, On, Available, Media, Voice, Little Cam, Medium Cam, Big Cam

The actual requests and actual status related to every user is displayed as icons; the icon for the first user (42) and the icon for the second user (43).

The following scenario illustrates examples of how multimedia information is shared between two users at two different locations.

The below examples, do not limit the scope of the invention, but are simple examples of sharing:
Audio only,
Audio only and chat,
Video and Audio.

The premises in the examples are based on the definitions below:
The audio-video system is a TV set with speaker as a main device for presenting picture and/or sound information.
An interactive two-way remote control (PDA) supports the user interactions; the user can manually navigate to other screens by using soft menu buttons; it displays the latest user input; it displays the current status of the system.
A media player (BS5) is the active device in accessing media files; it displays the information of an actual, selected and playing media; it displays the system status, including the status of all users that share information; the common status information may be considered as a bar with status display and at the same time as an interactive slider, onto which the user may change level, i.e. select modes of sharing.
System-wide rules of operation:
   Both parties must agree to add new media (presence on/off, media sharing on/off, voice sharing on/off, can sharing on/off).
   Within the agreed and playing media, parties can control their own ‘visual volume’ (small/medium/big) independently of each other.
   Both parties can remove media without asking permission, and when this happens, both experiences are moved down to the highest common denominator (on the slider).

### Scenario Audio Only:

| | |
|---|---|
| First user (primary home) | Second user (foreign home) |

Scenario description: Audio media, only
Stage: everything is off, no-one home
Comment: no actions

| | |
|---|---|
| Slider: off | Slider: off |
| Display: off | Display: off |
| Speakers: off | Speakers: off |
| Remote control: off | Remote control: off |
| Media player: off | Media player: off |

Scenario description: Audio media, only
Stage: first user coming home
Comment: first user comes home, enters the living room, which is
detected by the system, the state moves to ‘on’ automatically

| | |
|---|---|
| Slider: on | Slider: off |
| Display: off | Display: off |
| Speakers: off | Speakers: off |
| Remote control: on | Remote control: off |
| Media player: displays that nothing new | Media player: off |
| from second user | |

Scenario description: Audio media, only
Stage: home alone, listening to music
Comment: first user selects to listen to music

| | |
|---|---|
| Slider: on | Slider: off |
| Display: off | Display: off |
| Speakers: playing local audio media | Speakers: off |
| Remote control: provide play list info to | Remote control: off |
| the user | |
| Media player: provide the music to the | Media player: off |
| user | |

Scenario description: Audio media, only
Stage: available for others to invite
Comment: first user makes him/her available for other users

| | |
|---|---|
| Slider: available | Slider: off |
| Display: off | Display: off |
| Speakers: playing local audio media | Speakers: off |
| Remote control: enter the command that | Remote control: off |
| sharing is an option (set available in | |
| slider) | |
| Media player: provide the music to the | Media player: off |
| user | |

Scenario description: Audio media, only
Stage: second user comes home
Comment: second user comes home, enters the living room, which is
detected by the system, the state moves to ‘on’ automatically

| | |
|---|---|
| Slider: available | Slider: on |
| Indicate also (dimmed) that second user is | Indicate also (dimmed) that first user is |
| on | available |
| Display: off | Display: off |
| Speakers: playing local audio media | Speakers: off |
| Remote control: available | Remote control: is off unless picked up by |
| | second user; then it displays that first user |
| | is available. |
| Media player: provide the music to the | Media player: turns on and shows that the |
| user | first user also is home and has invited |
| | him/her to share media. The information |
| | about what the first user is playing is |
| | displayed for the second user |

Scenario description: Audio media, only
Stage: second user invites to share media
Comment: second user would like to listen to,
share, the music of the first user

| | |
|---|---|
| Slider: available | Slider: media |
| Indicate also (dimmed) that second user is | Indicate also (dimmed) that first user is |
| media | available |
| Display: off | Display: off |
| Speakers: playing local audio media | Speakers: off |
| Remote control: available, and shows that | Remote control: is off unless picked up by |
| second user scaled up to media | second user; then it displays the current |
| | status of the slider |
| Media player: provide the music to the | Media player: second user applies the |
| user. | slider to scale up (select) to media sharing |
| Displays on the slider that second user has | |
| scaled up to media sharing | |

### Scenario Audio Only and Chat

| | |
|---|---|
| First user (primary home) | Second user (foreign home) |

Scenario description: Audio media, only
Stage: second user invites first user to chat at voice level
Comment: first user accepts, and the music
starts playing synchronized at both homes

| | |
|---|---|
| Slider: media | Slider: voice |
| Indicate also (dimmed) that second user is | Indicate also (dimmed) that first user is |
| voice | media |
| Display: off | Display: off |
| Speakers: playing local audio media | Speakers: playing shared audio media |
| Remote control: slider showing both users | Remote control: is off unless picked up by |
| at the same level (media), show current | second user; then it displays slider with |
| media playing and voice request from | the same level for both users |
| second user is displayed (dimmed) | |
| Media player: provide the music to the | Media player: second user applies the |
| user. | slider to scale up (select) to voice chat |
| Displays on the slider that second user has | |
| scaled up to voice | |

Scenario description: Audio media, only
Stage: first user accepts to chat at voice level
Comment: first user accepts to chat in addition to audio media playing.
The voice starts at both homes; meanwhile the synchronized
music is still playing both places.

| | |
|---|---|
| Slider: voice | Slider: voice |
| Display: off | Display: off |
| Speakers: playing local audio media and | Speakers: playing shared audio media and |
| voice from second user | voice from first user |
| Remote control: first user accepts the | Remote control: is off unless picked up by |
| request to chat by scaling up the slider to | second user; then it displays slider with |
| the level (voice) of the second user | the same level for both users |
| Media player: provide the music to the | Media player: second user applies the |
| user. Shows playing album and track | slider to scale up (select) to voice chat |
| information. Shows slider is at the same | |
| level for both users. | |

Scenario description: Audio media, only
Stage: first user invites second user to share a picture.
Comment: first user would like to see a little
picture of the user in the second home.

| | |
|---|---|
| Slider: little camera (view small) | Slider: voice |
| Indicate also (dimmed) that second user is | indicate also (dimmed) that first user is |
| voice | little camera |
| Display: off | Display: off |
| Speakers: playing local audio media and | Speakers: playing shared audio media and |
| voice from second user | voice from first user |
| Remote control: first user request to share | Remote control: is off unless picked up by |
| picture by scaling up the slider to the level | second user; then it displays slider with |
| (little camera) of picture | first user inviting to share picture and |
| | current media playing |
| Media player: provide the music to the | Media player: shows playing album and |
| user. Shows playing album and track | track, and that first user has invited to |
| information. Shows slider is scaled up for | little camera |
| first user (to little camera) | |

Scenario description: Audio media, only
Stage: second user accepts to share picture and chooses big option.
Comment: second user prefers to look at a big picture and scales up to this selection.
Remark: instead of permissions for ‘all states’ it is permissions for ‘all new media’. Each
home is free to turn up and down the ‘visual volume’ of the camera, without asking
permission to do so. This to accommodate the user wishes to get the full benefits of the
actual screen size and performance.

| | |
|---|---|
| Slider: little camera (view small) | Slider: big camera |
| Indicate also (dimmed) that second user is | indicate also (dimmed) that first user is |
| big camera | little camera |
| Display: turn on and displays the picture | Display: turn on and displays the picture |
| of the second user (as small). In addition | of the first user (as big). In addition the |
| the media information is displayed, i.e. | media information is displayed (as small), |
| album and track information | i.e. album and track information |
| Speakers: playing local audio media and | Speakers: playing shared audio media and |
| voice from second user | voice from first user |
| Remote control: slider showing both users | Remote control: second user applies the |
| are at different levels (little cam and big | remote to scale up to big camera, as see |
| cam respectively), show current media | wants to see the first user properly |
| playing and big camera request from | |
| second user is displayed (dimmed) | |
| Media player: provide the music to the | Media player: shows playing album and |
| user. Shows playing album and track | track |
| information. Shows slider is scaled up for | |
| first user (to little camera) | |

Additional examples as above may be that:
The first user to scale up from small size picture to display a medium size picture of the second user.
The first user to scale up from medium size picture to display a big size picture of the second user.

### Scenario Video and Audio

Scenario related to combined audio/video is contained within the same methods as described above for Audio only.
Audio & Video Media, no sharing, no media
   Display is off, speakers are off.
Audio & Video Media, no sharing, audio/video media is playing
   display is active playing video;
   speakers are active playing audio.
Audio & Video Media, media sharing on, audio/video media is playing
   display is active playing video;
   speakers are active playing audio.
Audio & Video Media, voice sharing on, audio/video media is playing
   display is active playing video;
   speakers are active playing audio and remote voice.
Audio & Video Media, voice sharing on, small picture sharing, audio/video media is playing
   display is active playing video, and small pictures;
   speakers are active playing audio and remote voice.
Audio & Video Media, voice sharing on, medium picture sharing, audio/video media is playing
   Display is active playing video, and small picture of local user and medium picture of remote user;
   speakers are active playing audio and remote voice.
Audio & Video Media, voice sharing on, big picture sharing, audio/video media is playing
   Display is active playing video, as small picture, and small picture of local user and big picture of remote user;
   speakers are active playing audio and remote voice.

The size of the object presented on the screen may be configured according to application requirements e.g. full size cover, partly cover, full screen, partly screen and alike.

FIG. 5 illustrates a system block diagram of one embodiment of the invention.

The multimedia system may be a TV set with speakers (50). Two or more multimedia system similar to the outlined example may share media information. Different configurations may apply e.g.:
Two TV sets (50), alternatively two PC's, including a controller function (54).
Two media players (51), including a controller function (53).
Two IP based Webcams

Standard means are applied for the interconnection of devices i.e. to be able to offer resources/media and to apply/provide offered resources/media.

In the voice processing means, the sound recorded in a room is adjusted to filter the background noise from the sound signal; this is applicable in the interactive cam sessions.

The controller module (54) applies standard means in:
Graphical User Interface—WPF GUI;
Network management;
Database management;
Video/audio rendering;
Audio rendering;
Local camera and remote camera management;
Infrared control;
Sound gateway/switching;
Flash Proxy.

The controller module (53) applies standard means in:
Graphical User Interface—WPF GUI;
Network management;
Database management;
HID management.

A system according to the invention may be applied in many different multimedia systems, comprising means for a user to share an experienced event and the related video and sound information with one or more other users, and in an interactive dialog with the one or more other users to control the premises of the shared event.

Events include running applications/program and/or services accessed on the Internet. An example is to run an Internet browser on a multimedia device having access to the Internet, and share this application with another user which has no access to the internet.

1. An assembly comprising two or more media providers being adapted to communicate with each other, wherein:
each media provider is adapted to receive selected level information relating to one of a plurality of media exchange levels, each media exchange level identifying one or more of a predetermined plurality of different types of media information to exchange,
at least one of the media providers is adapted to output its selected level information to one or more of the other media providers,
one or more of the media providers, each having predetermined level information, being adapted to:
receive first level information from the at least one media provider,
compare the pertaining media provider's selected level information to the first level information and
if one or more types of media information are in common between the first level information and the pertaining media provider's selected level information, initiate data exchange with the at least one media provider, the data exchange taking place with all the types of media information in common.

2. An assembly according to claim 1, wherein a plurality of the media providers are adapted to access video media and exchange video media information, one of the types of media information being video media information.

3. An assembly according to claim 1, wherein a plurality of the media providers comprise means for deriving audio information from their surroundings and for exchanging audio information, one of the types of media information being audio information.

4. An assembly according to claim 1, wherein a plurality of the media providers comprise means for deriving image/video information relating to their surroundings and for exchanging image/video information, one of the types of media information being image/video information.

5. An assembly according to claim 1, wherein one or more of the media providers comprise means for a user to determine set level information and enter level information.

6. An assembly according to claim 1, wherein the determining/entering means of the at least one of the media players comprises a monitor/display for displaying set level information to the user, an ordering existing between the media exchange levels, each media exchange level having all types of media information of all lower ordered levels and at least one additional type of media information not present in any of the lower ordered levels, images or pictograms being illustrated on the display/monitor for each level, the images/pictograms being provided on the display/monitor along a predetermined curve and in the order of the levels, the image/pictogram of the set level being highlighted.

7. A media provider for use in the assembly according to claim 1.

8. A method of exchanging media information between two or more media providers communicating with each other, wherein:
each media provider receives selected level information relating to one of as plurality of media exchange levels, each media exchange level identifying one or more of a predetermined plurality of different types of media information to exchange,
at least one of the media providers outputs its level information to one or more of the other media providers,
one or more of the media providers, each having selected level information:
receives the first level information from the at least one media provider,
compares the pertaining media provider's selected level information to the first level information and
if one or more types of media information are in common between the first level information and the pertaining media provider's selected level information, initiates data exchange with the at least one media provider, the data exchange taking place with all the types of media information in common.

9. A method according to claim 8, wherein a plurality of the media providers access video media and exchange video media information, one of the types of media information being video media information.

10. A method according to claim 8, wherein a plurality of the media providers derive audio information from their surroundings and exchange audio information, one of the types of media information being audio information.

11. A method according to claim 8, wherein a plurality of the media providers derive image/video information relating to their surroundings and exchange image/video information, one of the types of media information being image/video information.

12. A method according to claim 8, further comprising the step of a user entering level information into at least one of the media providers.

13. A method according to claim 8, further comprising the step of displaying, on a display/monitor of a media provider, predetermined level information to a user, an ordering existing between the media exchange levels, each media exchange level having all types of media information of all lower ordered levels and at least one additional type of media information not present in any of the lower ordered levels, images or pictograms being illustrated on the display/monitor for each level, the images/pictograms being provided on the display/monitor along a predetermined curve and in the order of the levels, the image/pictogram of the set level being highlighted.
